(19) United States
(12) Patent Application Publication
(10) Pub. No.: US 2004/0148620 A1
(43) Pub. Date: Jul. 29, 2004

(54) Magnetic circuit, and optical pickup actuator and optical recording and/or reproducing apparatus using the magnetic circuit

(75) Inventors: Dae-Jong Jang, Anyang-si (KR); Byung-Youn Song, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/705,238

(22) Filed: Nov. 12, 2003

(30) Foreign Application Priority Data
Nov. 14, 2002 (KR) 2002-70655

(51) Int. Cl. G11B 7/00

(52) U.S. Cl. 720/683; 369/44.22

(57) ABSTRACT

A magnetic circuit, an optical pickup actuator and an optical recording and/or reproducing apparatus using the magnetic circuit. The magnetic circuit comprises a magnet, a tracking coil, and a first focusing/tilting coil. The magnet includes first, second, third and fourth magnet parts, the first and second magnet parts being disposed adjacent to each other and having opposite polarizations, the third and fourth magnet parts respectively neighboring the first and second magnet parts such that at least two sides thereof are enclosed by the first and second magnet parts, and having opposite polarizations to the first and second magnet parts, respectively. The tracking coil interacts with the first and second magnet parts for a tracking movement. The first focusing/tilting coil interacts with the first and third magnet parts and a second focusing/tilting coil which interacts with the second and fourth magnet parts, for a movement in at least one of a focusing direction and a tilting direction including the focusing direction.

### CROSS-REFERENCE TO RELATED APPLICATIONS

This application claims the benefit of Korean Patent Application No. 2002-70655, filed on Nov. 14, 2002, in the Korean Intellectual Property Office, the disclosure of which is hereby incorporated by reference.

### BACKGROUND OF THE INVENTION

1. Field of the Invention

The present invention relates to a magnetic circuit having an improved and slimmed structure with efficient tracking driving performance, and an optical pickup actuator and an optical recording and/or reproducing apparatus using the same.

2. Description of the Related Art

Generally, optical pickups are used in optical recording and/or reproducing apparatuses to record information on, and/or reproduce information from, a recording medium, for example, an optical disc, in a non-contact manner while moving along a radial direction of the optical disc.

Optical pickups include an optical pickup actuator for driving an objective lens in a tracking direction, a focusing direction, and/or a tilting direction to form a light spot on a particular track of the optical disc using light emitted from a light source. A tracking movement adjusts the objective lens in a radial direction of the optical disc so a light spot is formed in the center of a track of the optical disc.

An optical pickup actuator includes a bobbin movably installed on a base, suspension wires movingly supporting the bobbin on the base, and magnetic circuits positioned opposite to the bobbin and the base. Such an optical pickup actuator carries out tracking and focusing movements, i.e., biaxial movement.

It is a general desire in the marketplace that the optical recording and/or reproducing apparatuses are miniaturized and decrease in weight while having high recording density.

To achieve the requirement of high recording density, the optical pickup actuator must make triaxial or quadriaxial movements, including a tilting movement, in addition to the basic biaxial movements. To achieve the requirement of high recording density, the numerical aperture of the objective lens has been made larger and the wavelength of the light source has been shortened, and thus the tilting margin of the optical pickup actuator has been decreased. Thus, a triaxial- or quadriaxial-movement optical pickup actuator that can perform tilting in addition to the existing biaxial movements, is required. Triaxial movement includes focusing movements, tracking movements, and radial tilting movements. Quadriaxial movement includes focusing movements, tracking movements, radial tilting movements, and tangential tilting movements. The biaxial, triaxial, or quadriaxial movement capabilities of the optical pickup actuator depend on the configuration of the magnetic circuits of the actuator.

Also, for miniaturization of the optical pickup actuator, the height needs to be reduced.

FIG. 1 shows an example of a magnetic circuit used in a conventional optical pickup actuator allowing triaxial movement.

Referring to FIG. 1, the conventional magnetic circuit includes a 4-polarization magnet 1 divided into four polarized surfaces distributed into N polarizations and S polarizations, first and second focusing coils 3 and 5, respectively and first and second tracking coils 7 and 9, respectively.

The first and second focusing coils 3 and 5, respectively and the first and second tracking coils 7 and 9, respectively are positioned on side surfaces of a movable unit of the optical pickup actuator, i.e., a bobbin. The 4-polarization magnet 1 is positioned on a base so as to oppose the first and second focusing coils 3 and 5 and the first and second tracking coils 7 and 9.

As shown in FIG. 1, on a y-z coordinate plane, first through fourth polarizations 1a, 1b, 1c, and 1d of the magnet 1, respectively corresponding to first through fourth quadrants, are an N polarization, an S polarization, an N polarization, and an S polarization, respectively. The first focusing coil 3 interacts with the first and fourth polarizations 1a and 1d, and the second focusing coil 5 interacts with the second and third polarizations 1b and 1c. The first tracking coil 7 interacts with the first and second polarizations 1a and 1b, and the second tracking coil 9 interacts with the third and fourth polarizations 1c and 1d.

With the conventional magnetic circuit having the above-described structure, the movable unit of the optical pickup actuator can move in a focusing direction, a tracking direction, and a tilting direction.

When current flows in the first and second focusing coils 3 and 5 in a counterclockwise and a clockwise direction, respectively, a force acts in a positive focusing direction (z-axis direction). When the direction of the current flowing in the first and second focusing coils 3 and 5 is reversed, a force acts in a negative focusing direction (−z-axis direction). Thus, an objective lens mounted in the movable unit of the optical pickup unit is movable in focusing directions.

When current is supplied to the first and second focusing coils 3 and 5 in the same direction (clockwise direction), a force acts on the first focusing coil 3 in the positive focusing direction (z-axis direction) and a force acts on the second focusing coil 5 in the negative focusing direction (−z-axis direction). Likewise, when the direction of the current applied to the first and second focusing coils 3 and 5 is reversed, a force acts on the first focusing coil 3 in the negative focusing direction (−z-axis direction) and a force acts on the second focusing coil 5 in the positive focusing direction (z-axis direction). Thus, the movable unit of the optical pickup actuator can be driven in a tilt direction, e.g., in a radial tilting direction, so that the tilt of the objective lens positioned on the movable unit can be adjusted.

When current flows in the first and second tracking coils 7 and 9 in clockwise and counterclockwise directions, respectively, a force acts on the first and second tracking coils 7 and 9 in a negative y-axis direction. When the direction of the current flowing in the first and second tracking coils 7 and 9 is reversed, a force acts on the first and second tracking coils 7 and 9 in a positive y-axis direction). Thus, the movable unit of the optical pickup actuator is movable in the tracking direction so that the objective lens positioned on the movable unit can be controlled so as to correctly follow a track.

Accordingly, when the paired magnetic circuits having the above-described structure are installed on two sides of the movable unit of the optical pickup actuator, the movable unit can move in the focusing, tracking, and radial tilting directions, i.e., in triaxial directions.

However, due to arrangement of polarizations of the magnet 1 required for the triaxial movement, the conventional magnetic circuit, having the above-described structure, has the first and second tracking coils 7 and 9 disposed in the focusing direction, and the first and second tracking coils 7 and 9 having to be separated from each other. Since only part of the first and second tracking coils are effective e.g., portions marked with slanted lines in FIG. 1 in contributing to the tracking movement, it is difficult to slim the conventional magnetic circuit (reduce the height thereof). When the conventional magnetic circuit is slimmed, tracking efficiency is considerably deteriorated.

### SUMMARY OF THE INVENTION

The present invention provides a magnetic circuit having an improved and slimmed structure having efficient tracking, and an optical pickup actuator and an optical recording and/or reproducing apparatus using the same.

According to an aspect of the present invention, a magnetic circuit comprises a magnet, a tracking coil, and a first focusing/tilting coil. The magnet includes first, second, third and fourth magnet parts, the first and second magnet parts being disposed adjacent to each other and having opposite polarizations, the third and fourth magnet parts respectively neighboring the first and second magnet parts such that at least two sides thereof are enclosed by the first and second magnet parts, and having opposite polarizations to the first and second magnet parts, respectively. A tracking coil interacts with the first and second magnet parts for driving in a tracking direction. The first focusing/tilting coil interacts with the first and third magnet parts and a second focusing/tilting coil interacts with the second and fourth magnet parts, for driving in at least one of a focusing direction and a focusing and tilting direction.

The first and second magnet parts have a shape similar to a “ [symbol] ” shape, and are symmetric, so that the magnet circuit can be used when a driving center is required to be positioned in an upwardly direction.

The first and second magnet parts have a shape similar to an L-shape, and are symmetric, so that the magnetic circuit can be used when a driving center is required to be positioned in a downwardly direction.

According to an aspect of the invention, a position of a neutral zone between the first and third magnet parts and a position of a neutral zone between the second and fourth magnet parts along the focusing direction is adjusted so as to optimize a tracking sensitivity.

The magnet includes either a 4-polarization surface-polarized magnet or a pair of 2-polarization surface-polarized magnets. The magnetic circuit can be selectively used for biaxial, triaxial, or quadriaxial movements by controlling the direction of current applied to the first and second focusing/tilting coils. According to an aspect of the present invention, at least one of the first and second focusing/tilting coils and the tracking coil is a fine pattern coil.

According to another aspect of the present invention, an optical pickup actuator comprises a bobbin, a support, and a pair of magnetic circuits. An objective lens is mounted on the bobbin. The support is fixedly attached at one end to a holder placed on a side of a base, and fixedly attached at the other end to a side surface of the bobbin, so the bobbin is movable on the base. The pair of magnetic circuits are installed on the side surfaces of the bobbin and on the base so as to be opposed to each other. The magnetic circuit includes a magnet, a tracking coil, and a first focusing/tilting coil. The magnet includes first, second, third and fourth magnet parts, the first and second magnet parts being disposed adjacent to each other and having opposite polarizations, the third and fourth magnet parts respectively neighboring the first and second magnet parts such that at least two sides thereof are enclosed by the first and second magnet parts, and having opposite polarizations to the first and second magnet parts, respectively. The tracking coil interacts with the first and second magnet parts for driving the objective lens in a tracking direction. The first focusing/tilting coil interacts with the first and third magnet parts and a second focusing/tilting coil which interacts with the second and fourth magnet parts, for driving the objective lens in at least one of a focusing direction, and a tilting and focusing direction.

The support is fixed to a side surface that is different from a side surface to which the magnetic circuits of the bobbin are disposed.

Either the first and second focusing/tilting coils and the tracking coil, or the magnet is positioned on a side surface of the bobbin, and the other is positioned on the base.

According to yet another aspect of the present invention, an optical recording and/or reproducing apparatus includes an optical pickup and a controlling unit. The optical pickup includes an actuator for driving an objective lens and is movably installed along a radial direction of a disc so as to record information on the disc and/or reproduce information recorded on the disc. The controlling unit controls a focusing servo and a tracking servo of the optical pickup. The actuator includes a bobbin, a support, and a pair of magnetic circuits. An objective lens is mounted on the bobbin. The support is fixedly attached at one end to a holder placed on a side of a base and fixedly attached at the other end to a side surface of the bobbin, so the bobbin is movable on the base. The pair of magnetic circuits are positioned on the side surfaces of the bobbin that is on the base so as to oppose each other. The magnetic circuit includes a magnet, a tracking coil, and a first focusing/tilting coil. The magnet includes first, second, third and fourth magnet parts, the first and second magnet parts disposed adjacent to each other and having opposite polarizations, the third and fourth magnet parts respectively neighboring the first and second magnet parts such that at least two sides thereof are enclosed by the first and second magnet parts, and having opposite polarizations to the first and second magnet parts, respectively. The tracking coil interacts with the first and second magnet parts for driving the objective lens in a tracking direction. The first focusing/tilting coil interacts with the first and third magnet parts and a second focusing/tilting coil interacts with the second and fourth magnet parts, for driving the objective lens in at least one of a focusing direction and a tilting direction including the focusing direction.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments taken in conjunction with the accompanying drawings in which:

FIG. 1 shows an example of a magnetic circuit used in a conventional optical pickup actuator;

FIG. 2 is a partial exploded perspective view of an optical pickup actuator using a magnetic circuit according to an aspect of the present invention;

FIG. 3 schematically shows a magnetic circuit according to an aspect of the present invention;

FIG. 4 is a plan view of a magnet from the magnetic circuit of FIG. 3;

FIG. 5 shows change in a distribution of a magnetic flux affecting tracking control according to change in a position of a polarization line in a focusing direction in the magnet shown in FIG. 4;

FIG. 6 schematically shows a magnetic circuit according to another embodiment of the present invention;

FIG. 7 is a plan view of a magnet from the magnetic circuit of FIG. 6;

FIGS. 8A and 8B are views for explaining a principle of moving a movable unit of the optical pickup actuator in a tracking direction using the magnetic circuit according an aspect of the present invention;

FIGS. 9A and 9B are views for explaining a principle of moving the movable unit of the optical pickup actuator in a focusing direction using the magnetic circuit according to an aspect of the present invention;

FIGS. 10A and 10B are views for explaining a principle of moving the movable unit of the optical pickup actuator in a radial tilting direction using the magnetic circuit according to an aspect of the present invention; and

FIG. 11 schematically shows the structure of an optical recording and/or reproducing apparatus using an optical pickup actuator an aspect of the present invention.

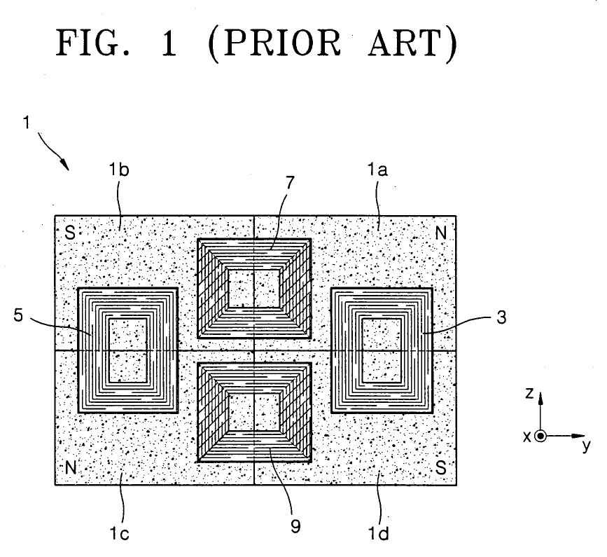

### DETAILED DESCRIPTION OF THE INVENTION

Reference will now be made in detail to the embodiments of the present invention, examples of which are illustrated in the accompanying drawings, wherein like reference numerals refer to the like elements throughout. The embodiments are described below to explain the present invention by referring to the figures.

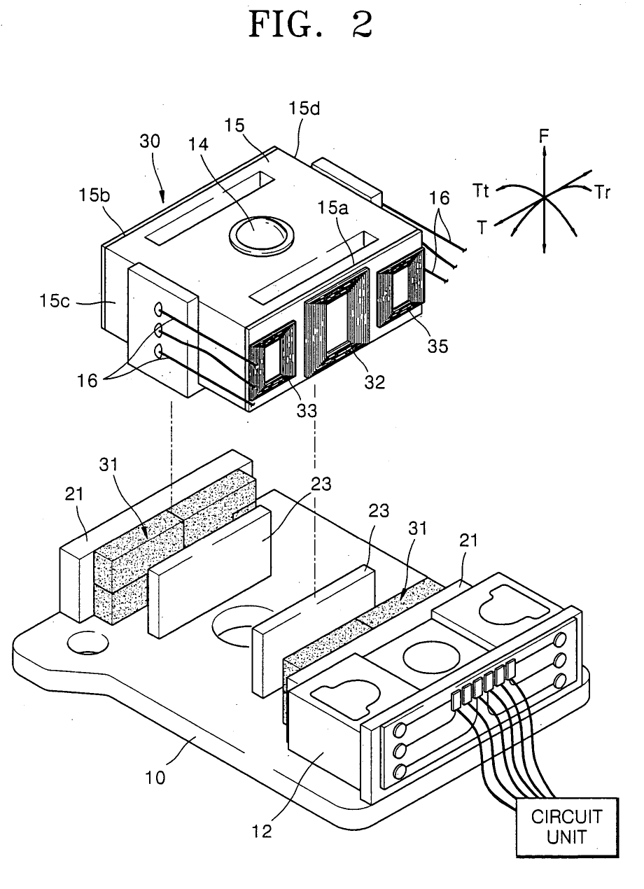

FIG. 2 is a partial exploded perspective view of an optical pickup actuator using a magnetic circuit according to an aspect of the present invention. In FIG. 2, F, T, Tr, and Tt denote focusing directions, tracking directions (according to a radial direction of a disc-type recording medium), radial tilting directions, and tangential tilting directions, respectively.

Referring to FIG. 2, the optical pickup actuator according to an aspect of the present invention includes a bobbin 15, supports 16, and a pair of magnetic circuits. The bobbin 15 is moveably installed on a base 10 and has an objective lens 14 mounted therein. One end of each of the supports 16 is fixedly attached to a holder 12 (not shown) and the other end of each of the supports is fixedly attached to side surfaces 15c and 15d of the bobbin 15 so as to enable the bobbin 15 to be movably supported on the base 10. The holder 12 is positioned on the base 10. The magnetic circuits are positioned on both side surfaces 15a and 15b of the bobbin 15 so as to oppose each other.

Also, the optical pickup actuator according to an aspect of the present invention, as shown in FIG. 2, may further include outer yokes 21 and/or inner yokes 23 to guide a magnetic flux generated by the magnets 31. The supports 16 are fixed on the side surfaces 15c and 15d of the bobbin 15, and not on the side surfaces 15a and 15b of the bobbin 15 on which the magnetic circuits are disposed. The supports may be wires or plate springs.

In FIG. 2, the optical pickup actuator according to an aspect of the present invention includes six wires as the supports 16. Alternatively, a lesser number of wires e.g., four wires may be used as the supports 16.

The above-described magnetic circuit can perform biaxial, triaxial, and quadriaxial movements. The number of wires included in the optical pickup actuator depends on whether biaxial, triaxial, and quadriaxial movements of the actuator are desired. .

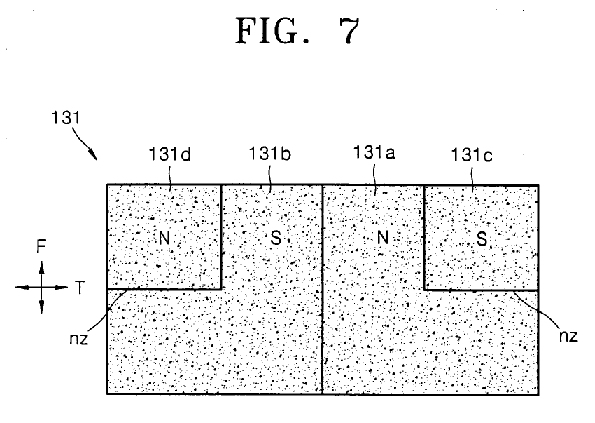

Each of the pair of magnetic circuits includes a tracking coil 32, first and second focusing/tilting coils 33 and 35, and a magnet 31 (or magnet 131 shown in FIGS. 6 and 7). The tracking coil 32 moves the bobbin 15 in the tracking directions. The first and second focusing/tilting coils 33 and 35 move the bobbin 15 in the focusing directions, or the tilting and the focusing directions. The magnet 131 is positioned so as to be opposite to the first and second focusing/tilting coils 33 and 35 and the tracking coil 32.

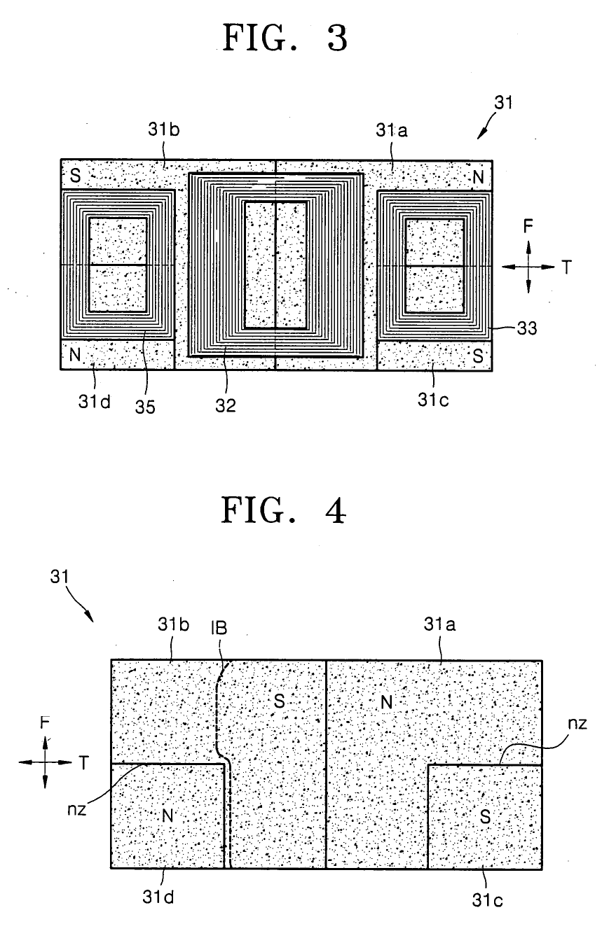

A magnetic circuit according to an aspect of the present invention shown in FIGS. 3 and 4 may be used as the magnetic circuit of the optical pickup actuator shown in FIG. 2. Alternatively, a magnetic circuit according to another embodiment] aspect of the present invention shown in FIGS. 6 and 7 may be used as the magnetic circuit of the optical pickup actuator shown in FIG. 2. That is, the optical pickup actuator shown in FIG. 2 may include a magnet 131 shown in FIG. 7 instead of the magnet 31 shown in FIG. 4.

In an optical recording and/or reproducing apparatus, tilt generates coma aberration so that a RF signal is deteriorated. With high recording density, the tilting margin of the optical pickup actuator is low due to the use of an objective lens having a high numerical aperture and a light source having a short wavelength. As a result, coma aberration is generated, thus deteriorating the RF signal and reducing access time. In particular, generated coma aberration can reduce an optical output power below a level required for reliably recording in a high-speed and high-density recording apparatuses, particularly, a high-speed CD-RWs, and thus recording quality can be less than desired. Thus, the requirement for compensation with respect to an AC component (rolling) of tilt, particularly, radial tilt, in the high-density reproducing apparatuses and the high-speed and high-density recording apparatuses is increased.

Thus, in high-speed and high-density recording and/or reproducing apparatuses, the optical pickup actuator must be highly sensitive and rolling of the optical pickup actuator must be reduced.

The optical pickup actuator according to an aspect the present invention can be miniaturized using the asymmetrical features of the magnetic circuit, as described below, and have excellent tracking sensitivity. Further, since rolling of the optical pickup actuator can be reduced by using the magnet 31 or the magnet 131 of the magnetic circuit according to aspects of the present invention, the optical pickup actuator can be used with high-speed and high-density devices. Reasons why rolling is reduced by selectively using the magnetic circuits according to aspects of the present invention will be described below.

The magnet 31 or 131 has a polarized structure to interact with the focusing/tilting coils 33 and 35 and the tracking coil 32, and to move the bobbin 15 in at least one of the focusing direction, the tilting and focusing direction, and the tracking direction.

Referring to FIGS. 3 and 4, in the magnetic circuits according to an aspect of the present invention, the magnet 31 has a polarized structure including first and second magnet parts 31a and 31b and third and fourth magnet parts 31c and 31d. The first and second magnet parts 31a and 31b are disposed adjacent to each other, and have opposite polarizations. The third and fourth magnet parts 31c and 31d respectively neighbor the first and second magnet parts 31a and 31b and at least two sides of the third and fourth magnet parts 31c and 31d are enclosed by the first and second magnet parts 31a and 31b, respectively. Also, the third and fourth magnet parts 31c and 31d have opposite polarizations to the first magnet part 31a and the second magnet part 43b, respectively. In FIG. 3, F and T denote focusing directions and tracking directions, respectively.

As shown in FIG. 4, in the magnet 31, two sides of each of the third and fourth magnet parts 31c and 31d are enclosed by the first and second magnet parts 31a and 31b. The first and second magnet parts 31a and 31b have a “ [symbol] ” shape, and are substantially symmetric.

In FIG. 4, IB denotes the distribution of a magnetic flux in the second magnet part 31b affecting tracking control. The distribution of a magnetic flux in the first magnet part 31a is substantially symmetric to the distribution of the magnetic flux in the second magnet part 31b. Directions of the magnetic fluxes of the first and second magnetic parts 31a and 31b are opposite each other.

When the magnet 31 has the polarization structure shown in FIG. 4, the tracking coil 32 interacts with the first and second magnet parts 31a and 31b. Also, the first focusing/tilting coil 33 interacts with the first and third magnet parts 31a and 31c, and the second focusing/tilting coil 35 interacts with the second and fourth magnet parts 31b and 31d.

According to an aspect of the present invention, at least one of the focusing/tilting coils 33 and 35 and the tracking coil 32 is a fine pattern coil. Since the fine pattern coil, made by patterning a coil shape on a film, is slim, the fine pattern coil can contribute greatly to reducing the size and weight of the movable unit of the optical pickup actuator. FIG. 2 shows an example of the first and second focusing/tilting coils 33 and 35 and the tracking coil 32 formed as fine pattern coils. The first and second/tilting coils and the tracking coil may be formed as fine pattern coils on a single film.

Alternatively, a bulk-type coil made by winding copper wires may be provided as the focusing/tilting coils 33 and 35 and/or the tracking coil 32.

The magnetic circuit according to an aspect of the present invention having a magnet 31 with a polarization structure as shown in FIG. 4 may be used with an optical pickup actuator in which a driving center must be positioned in an upwardly direction to improve rolling characteristics.

Since the magnetic circuit according to an aspect of the present invention includes a single tracking coil 32 per side, an effective coil length of the tracking coil 32 contributing to tracking movement can be longer, compared with a conventional structure in which two tracking coils are disposed in the focusing direction. Therefore, a slimmed optical pickup actuator having a reduced height of the optical pickup actuator can be obtained with efficient tracking performance.

The magnetic circuits according to an aspect of the present invention can further improve tracking sensitivity using the asymmetry of the magnetic flux intensity distribution due to the polarization structure of the magnet 31.

More specifically, since the magnet 31 has the polarized structure shown in FIG. 4, in the magnetic circuits according to an aspect of the present invention, in order to improve the tracking sensitivity by changing the magnetic flux intensity distribution IB affecting tracking control, it is possible to change a position of a neutral zone nz between the first and third magnet parts 31a and 31c and a position of a neutral zone nz between the second and fourth magnet parts 31b and 31d along the focusing direction to achieve a desired margin of linearity.

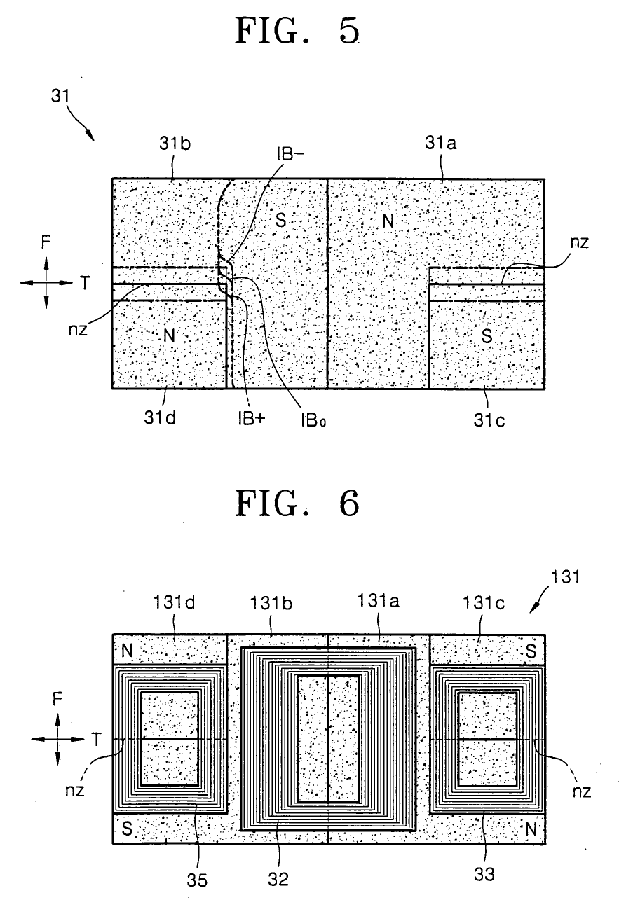

As shown in FIG. 5, in the magnetic circuit according to an aspect of the present invention, the magnetic flux intensity distribution IB has an asymmetric shape in the focusing direction. When the position of the neutral zone nz is changed, the shape of the magnetic flux intensity distribution IB changes. Thus, the intensity of the magnetic flux can be increased or reduced by changing the position of the neutral zone nz. The reason is that the first and second magnet parts 31a and 31b have the “ [symbol] ” shape and the third and fourth magnet parts 31c and 31d having opposite polarization to the first and second magnet parts 31a and 31b, respectively, are disposed to neighbor the first and second magnet parts 31a and 31b.

In FIG. 5, IB₀ denotes a magnetic flux intensity distribution when the neutral zone nz is positioned substantially in the center of widths of the first and second magnet parts 31a and 31b in the focusing direction. IB+ denotes a magnetic flux intensity distribution when the neutral zone nz is positioned below the center of the width of the first and second magnet parts 31a and 31b in the focusing direction. In this case, the intensity of the magnetic flux contributing to tracking control increases compared with the case where the neutral zone nz is positioned in the center of the width. IB− denotes a magnetic flux intensity distribution when the neutral zone nz is positioned above the center of the width in the focusing direction. In this case, the intensity of the magnetic flux contributing to tracking control is reduced compared with the case where the neutral zone nz is positioned below the center of the width.

As described above, the intensity of the magnet flux affecting tracking control can be changed by changing the position of the neutral zone nz.

As described above, tracking sensitivity can be improved by changing the position of the neutral zone nz to optimize or maximize the intensity of magnetic flux affecting tracking control within the range of satisfaction of a desired linearity.

In the magnetic circuit according to an aspect of the present invention, the position of the neutral zone nz is determined according to the optical pickup actuator that is used to obtain an excellent tracking sensitivity. Changing the position of the neutral zone nz means that the lengths of sides, shapes, and areas of the first through fourth magnet parts 31a, 31b, 31c, and 31d along the focusing and tracking directions are changed.

The magnetic circuit according to an aspect of the present invention has excellent linearity.

As shown in FIG. 2, if the coils 32, 33, and 35 are installed in the movable unit of the optical pickup actuator, the magnet 31 is installed opposite to the coils 32, 33, and 35 and substantially perpendicular to the base 10. If the optical pickup actuator moves for focusing control and/or tracking control, the coils 32, 33, and 35 also move in the focusing direction and/or the tracking direction with respect to the magnet 31. Since the magnet 31 has a two-division structure divided in the focusing direction and the tracking direction, respectively, the magnet 31 has a wide linear area that can move by a predetermined distance with respect to the same driving current, and thus has excellent linearity.

Referring to FIGS. 6 and 7, the magnetic circuit according to an aspect of the present invention has the same coil structure as previously described, but the polarization structure of the magnet is different. In FIGS. 6 and 7, the same reference numerals are used to denote elements that are the same as in FIGS. 3 through 5, and descriptions of such elements will not be repeated.

According to an aspect of the present invention, a magnet 131 has a structure including first and second magnet parts 131a and 131b and third and fourth magnet parts 131c and 131d. The first and second magnet parts 131a and 131b are disposed adjacent to each other, and have opposite polarizations. The third and fourth magnet parts 131c and 131d respectively neighbor the first and second magnet parts 131a and 131b and at least two sides of the third and fourth magnet parts 131c and 131d are enclosed by the first and second magnet parts 131a and 131b, respectively. Also, the third and fourth magnet parts 131c and 131d have opposite polarizations to the first and second magnet parts 131a and 131b, respectively.

As shown in FIG. 7, in the magnet 131, two sides of each of the third and fourth magnet parts 131c and 131d are enclosed by the first and second magnet parts 131a and 131b, the first and second magnet parts 131a and 131b have a “L” shape The magnet 131 includes the first and second magnet parts 131a and 131b having the similar to “L” shape.

When the magnet 131 has the polarization structure shown in FIG. 7, a tracking coil 32 interacts with the first and second magnet parts 131a and 131b. Also, a first focusing/tilting coil 33 interacts with the first and third magnet parts 131a and 131c, and a second focusing/tilting coil 35 interacts with the second and fourth magnet parts 131b and 131d.

The magnetic circuit according to another aspect of the present invention, having the magnet 131 of the polarized structure as shown in FIG. 7, can be used with an optical pickup actuator in which a driving center must be positioned in a downwardly direction.

The magnetic circuit according to an aspect of the present invention has excellent tracking sensitivity and excellent linearity. However, the magnetic circuit according to another aspect of the present invention has a different driving center. To improve the tracking sensitivity, it is possible to change the position of a neutral zone nz between the first and third magnet parts 131a and 131c and between the second and fourth magnet parts 131b and 131d, along the focusing direction, within a range satisfying a desired degree of linearity with respect to focusing control. Since the operational effect of the magnetic circuit according to this aspect of the present invention can be understood sufficiently from the above description of the operational effect of the magnetic circuit according to other aspects of the present invention, a description thereof will be omitted.

As shown in FIGS. 3 through 7, the first through fourth magnet parts 31a and 131a, 31b and 131b, 31c and 131c, and 31d and 131d of the magnets 31 and 131 have an N polarization, an S polarization, an S polarization, and an N polarization, respectively. Bottom surfaces of the first through fourth magnet parts 31a and 131a, 31b and 131b, 31c and 131c, and 31d and 131d have polarizations opposite to what is shown in FIGS. 3 through 7, respectively.

In the magnetic circuit according to an aspect of the present invention, a 4-polarization magnetized surface-polarized magnet having the structure shown in FIGS. 4 and 7 is used as the magnets 31 and 131.

Alternatively, the magnets 31 and 131 of the magnetic circuit, according to an aspect of the present invention may be configured by disposing a pair of 2-pole magnetized surface-polarized magnets. For example, a two-pole magnetized surface-polarized magnet having the first and third magnet parts 31a and 31c and a two-pole magnetized surface-polarized magnet having the second and fourth magnet parts 31b and 31d may be combined to make the magnet 31.

If a surface-polarized magnet is used as the magnets 31 and 131 as described above, an air gap magnetic flux density is improved so that efficiency of the magnets 31 and 131 is also improved.

Alternatively, the magnets 31 and 131 may be obtained by disposing a manufactured magnet in the polarized structures shown in FIGS. 4 and 7.

Although the first through fourth magnet parts of the magnets 31 and 131 are disposed adjacent to one another in FIGS. 2 through 7, this is only an example of a possible arrangement. Alternatively, the first through fourth magnet parts of the magnets 31 and 131 may be disposed a predetermined distance apart from one another.

Since the magnet 31 having the polarized structure shown in FIG. 4 and the magnet 131 having the polarized structure shown in FIG. 7 have opposite asymmetry in intensity distributions of magnetic flux, the driving centers of the magnets 31 and 131 are different from each other. Thus, the magnet 31 having the polarized structure shown in FIG. 4, or the magnet 131 having the polarized structure shown in FIG. 7, is used selectively according to the optical pickup actuator, so that the driving center of the magnets 31 and 131 is changed, and rolling of the optical pickup actuator is reduced.

Thus, the optical pickup actuator according to an aspect of the present invention reduces rolling by using various ones of the magnetic circuits according to various aspects of the present invention. Rolling should be reduced when using a high-density and high-speed recording medium. According to an aspect of the present invention, rolling can be reduced by changing the driving center as explained below.

A correlation between center of weight, center of support, and center of driving of the movable unit of the optical pickup actuator in which the objective lens is mounted affects rolling.

The bobbin itself, the objective lens, soldering, the coil member installed in the bobbin, the PCB, and an optical element additionally mounted on the movable unit, etc., are components affecting the center of weight. The number of wires used as a support, the diameter of the wire, and length of the wire are factors affecting the center of support.

Before mass-production, an optical actuator goes through several processes of modification in order to optimize its design. The center of weight and/or the center of support can be changed in order to reduce rolling of the optical pickup actuator. However, when design values of the components affecting the center of weight and the center of support are changed, other design-related aspects of the performance of the actuator are also affected, it is difficult to change the center of weight and/or the center of support so as to reduce rolling.

That is, it is difficult to specify a change in the center of weight and/or the center of support for reducing rolling in the modifying processes when manufacturing the optical pickup actuator.

The center of driving of the magnetic circuit according to one embodiment of the present invention is positioned upwardly, and the center of driving of the magnetic circuit according to another aspect of the present invention is positioned downwardly.

Since the center of driving of the magnetic circuit can be easily changed to be positioned upwardly or downwardly by selectively using the magnetic circuits according to aspects of the present invention, it is possible to manufacture an optical pickup actuator that reduces rolling by appropriately selecting the magnetic circuits considering overall conditions of the optical pickup actuator.

For example, in an optical pickup actuator used in a compatible optical recording and/or reproducing apparatus that can be used for reproducing of DVDs and recording and reproducing of CDs at a high speed, because the objective lens is large, the center of weight of the magnetic circuit of the optical pickup actuator is positioned upwardly. Thus, in this case, the center of driving of the magnetic circuit is positioned below the center of weight by using the magnetic circuit according to another aspect of the present invention, thereby reducing rolling of the optical pickup actuator to within an allowable range.

In an optical pickup actuator used in a compatible optical recording and/or reproducing apparatus that can be used for reproducing of DVDs and reproducing and recording of CDs and that can control tilt, since six wires are used, the center of support is positioned downwardly in comparison, with no controlling of tilt, and the center of weight is positioned below the center of support. Also, in an optical pickup actuator used in a DVD-CD compatible optical recording and/or reproducing apparatus that can be used to record and/or reproduce information on, for example, a DVD-RAM, the center of weight is positioned downwardly. Thus, in this case, the center of driving of the magnetic circuit is positioned upwardly by using the magnetic circuit according to an aspect of the present invention, thereby reducing rolling of the optical pickup actuator to within an allowable range.

As described above, according to an aspect of the present invention, the center of driving can be changed by selectively using the magnet having the polarization structure shown in FIG. 4 or the magnet having the polarization structure shown in FIG. 7, according to the type of optical pickup actuator, thereby reducing rolling of the optical pickup actuator.

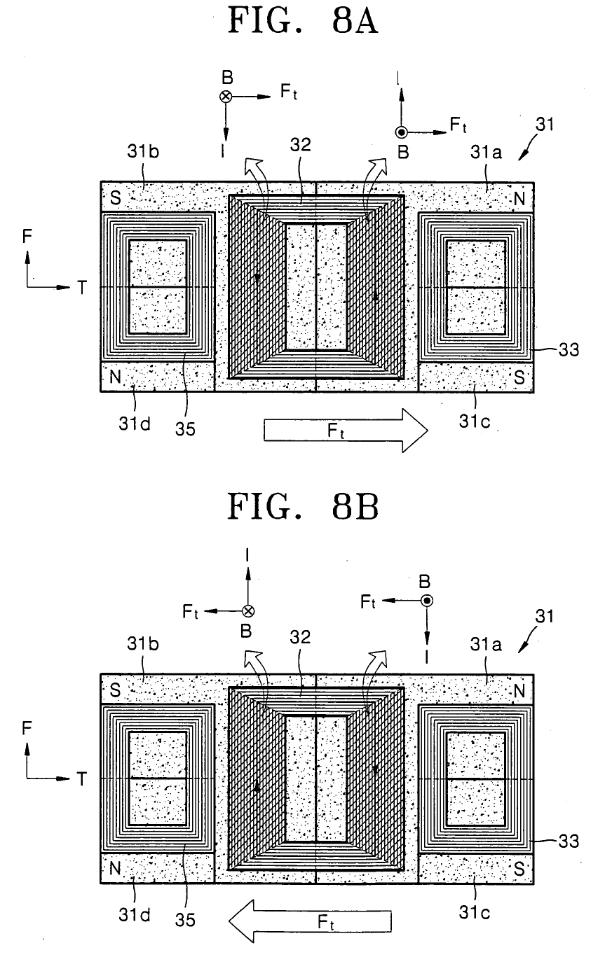

Hereinafter, an example of an optical pickup actuator employing the magnetic circuit according to an aspect of the present invention, described with reference to FIGS. 3 through 5, will be described in order to explain the operation of the optical pickup actuator according to the present invention. FIGS. 8A through 10B show an example in which the first through fourth magnet parts 31a, 31b, 31c, and 31d of the magnet 31 are an N polarization, an S polarization, an S polarization, and an N polarization, respectively, on a T-F (tracking direction-focusing direction) coordinate plane, and the tracking coil 32 and the first and second focusing/tilting coils 33 and 35 are installed on the movable unit of the optical pickup actuator.

The optical pickup actuator according to the present invention, as shown in FIGS. 8A through 10B, drives the objective lens 14 mounted in the bobbin 15 of the movable unit in the tracking, focusing, and tilting directions. That is, the optical pickup actuator according to the present invention performs biaxial, triaxial, and quadriaxial movements of the objective lens 14 mounted in the bobbin 15 of the movable unit.

FIGS. 8A and 8B are views for explaining a principle of moving the movable unit of the optical pickup actuator in the tracking direction.

As shown in FIG. 8A, when current flows through the tracking coil 32 in a counterclockwise direction, a magnetic force Ft acts on the tracking coil 32 in a right direction (+T direction). In contrast, as shown in FIG. 8B, when current flows through the tracking coil 32 in a clockwise direction, the magnetic force Ft acts on the tracking coil 32 in a left direction (−T direction).

As described above, depending on the direction of the current applied to the tracking coil 32, the magnetic force acts on the movable unit of the optical pickup actuator, according to an aspect of the present invention, in the right or left direction. As a result, the movable unit moves in the tracking directions. Thus, by properly controlling the direction of the current applied to the tracking coil 32, the objective lens 14 mounted in the movable unit can follow a track (the center of the track).

Since the magnetic circuit of the optical pickup actuator according to the present invention includes a single tracking coil 32 per magnet side, an effective coil length, as marked with slanted lines in FIGS. 8A and 8B, of the tracking coil 32 contributing to a tracking movement is longer, compared with a conventional structure in which two tracking coils are disposed per side in the focusing direction. Therefore, it is possible to make a slimmer optical pickup actuator while securing a desired tracking performance.

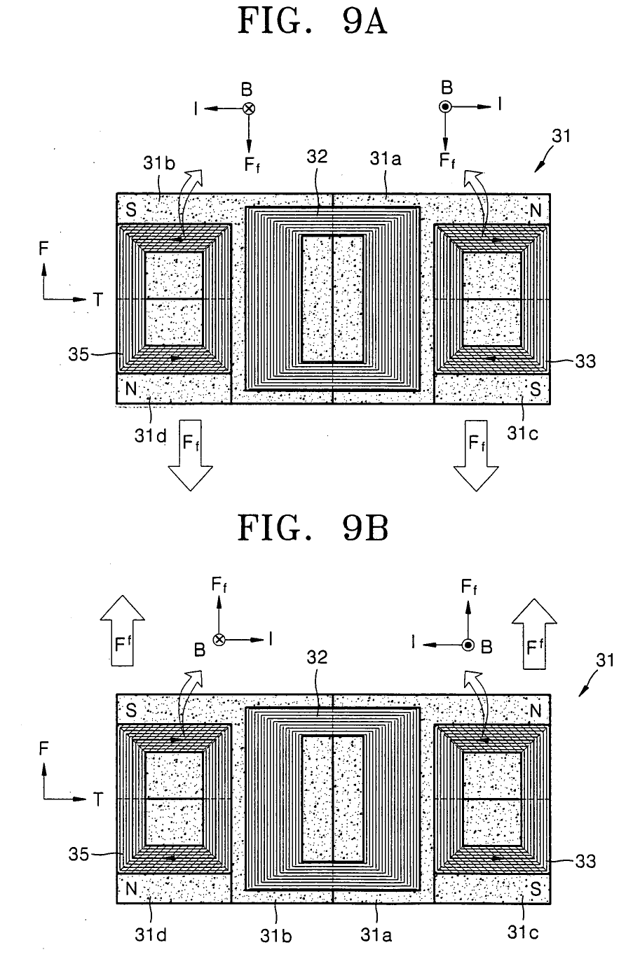

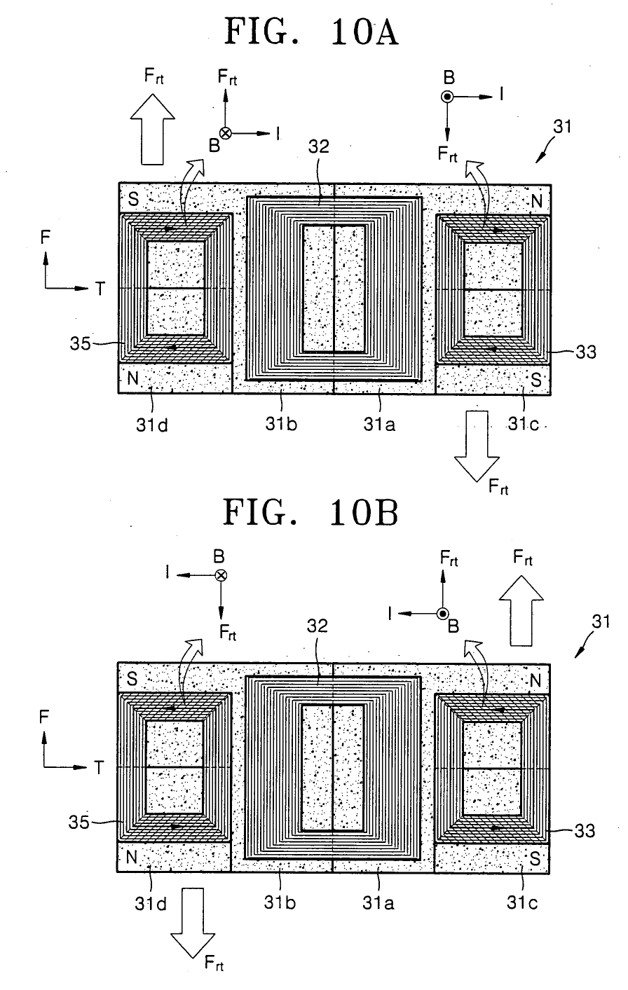

FIGS. 9A and 9B are views explaining a principle of moving the movable unit of the optical pickup actuator in the focusing direction.

As shown in FIG. 9A, when current flows through the first focusing/tilting coil 33 in the clockwise direction, and current flows through the second focusing/tilting coil 35 a magnetic force Ft acts downward on the first and second focusing/tilting coils 33 and 35. Also, as shown in FIG. 9B, when current flows through the first and second focusing/tilting coils 33 and 35 in opposite directions to the directions shown in FIG. 9A, a magnetic force Ft acts upward on the first and second focusing/tilting coils 33 and 35.

As described above, according to the directions of the current applied to the first and second focusing/tilting coils 33 and 35, the magnetic force acts in an upward or downward direction, that is, in the +focusing direction or the −focusing direction of the movable unit of the optical pickup actuator. As a result, the movable unit moves in the focusing directions. Thus, by properly controlling the directions of the current applied to the first and second focusing/tilting coils 33 and 35, the position of the objective lens 14 mounted in the movable unit can be varied in the focusing directions.

FIGS. 10A and 10B are views for explaining a principle of moving the movable unit of the optical pickup actuator in the radial tilting direction. When the movable unit moves in the radial tilting direction, an asynchronization signal is input to the first and second focusing/tilting coils 33 and 35 of one magnetic circuit.

As shown in FIG. 10A, when current flows through the first and second focusing/tilting coils 33 and 35 in the clockwise direction, a magnetic force Frt acts downwardly on the first focusing/tilting coil 33 and a magnetic force Frt acts upwardly on the second focusing/tilting coil 35. Also, as shown in FIG. 10B, when current flows through the first and second focusing/tilting coils 33 and 35 in opposite directions to the directions shown in FIG. 10A, the magnetic force Frt acts upwardly on the first focusing/tilting coil 33 and the magnetic force Frt acts downwardly on the second focusing/tilting coil 35.

As described above, according to the directions of the current applied to the first and second focusing/tilting coils 33 and 35, the magnetic force Frt acts upwardly on one side of the movable unit of the optical pickup actuator and downwardly on the other side in the radial tilting direction. As a result, the movable unit moves in the radial tiling direction. Thus, by properly controlling the directions of the current applied to the first and second focusing/tilting coils 33 and 35, the radial tilt of the objective lens 14 mounted in the movable unit can be adjusted.

In FIGS. 9A, 9B, 10A, and 10B, the hatched portions of the first and second focusing/tilting coils 33 and 35 indicate effective coil portions that contribute to the generation of a magnetic force.

As described above, in the optical pickup actuator having the magnetic circuit according to an aspect of the present invention, the movable unit can move biaxially, that is, in the focusing and tracking directions.

In addition, when an asynchronization signal is input to the first and second focusing/tilting coils 33 and 35 of each of the magnetic circuits, since the movable unit can be adjusted in the radial tilting direction, the movable unit can perform triaxial movement. In this case, six wires are required.

As described above, the movable unit of the optical pickup actuator having the magnetic circuit according to aspects of the present invention can also move biaxially or triaxially.

Since the optical pickup actuator includes the pair of magnetic circuits, an asynchronous signal is input to the pair of magnetic circuits so that a magnetic force acts downwardly on the magnetic circuit disposed at one side 15a of the bobbin 15, as described with reference to FIG. 9A, and a magnetic force acts upwardly on the magnetic circuit disposed at the other side 15b of the bobbin 15, as described with reference to FIG. 9B. As a result, the movable unit can move in the tangential tilting direction.

Accordingly, when the current that is applied to the first and second focusing/tilting coils 33 and 35 of the pair of magnetic circuits are controlled as described above, the movable unit of the optical pickup actuator according to an aspect of the present invention can move quadriaxially.

In the optical pickup actuator shown in FIG. 2, coils of the magnetic circuits are installed on the movable unit, i.e., the bobbin 15, and magnets of the magnetic circuits are installed on the base 10. However, this is only an example and the locations of the coils and the magnet of the magnetic circuits may be reversed. The optical pickup actuator according to aspects of the present invention is not restricted to the structure shown in FIG. 2 and various modifications are possible.

As described above, an aspect of the present invention provides an optical pickup actuator which can perform a tilting movement without a large sensitivity (in particular, tracking sensitivity) loss, even when the height is restricted because of a restriction of the height required by the optical system of the optical pickup. Such an optical pickup actuator according an aspect of to the present invention can be used in recording and/or reproducing apparatuses which record and/or reproduce information on DVD-RAM-family recording media or DVD-RAM-and CD-family recording media.

An aspect of the present invention also provides an optical pickup actuator which does not perform a tilting movement and is restricted in height. Such an optical pickup actuator can be used in recording and/or reproducing apparatuses of a CD-DVD compatible type or in recording and/or reproducing apparatuses that record and/or reproduce information on CD-RWs, DVD-ROMs, or the like.

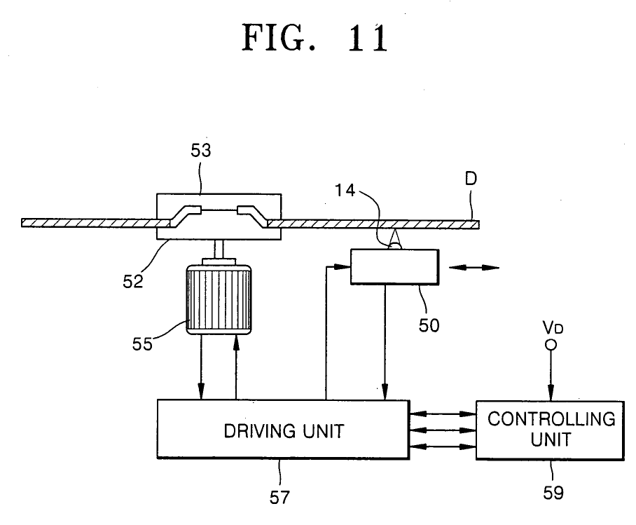

FIG. 11 schematically shows a structure of an optical recording and/or reproducing apparatus using an optical pickup actuator according to an aspect of the present invention.

Referring to FIG. 11, the optical recording and/or reproducing apparatus includes a spindle motor 55 for rotating an optical information storage medium, for example, an optical disc D, an optical pickup 50 installed to be movable in a radial direction of the optical disc D and records and/or reproduces information on the disc, a driving unit 57 for driving the spindle motor 55 and the optical pickup 50, and a controlling unit 59 for controlling a focusing servo, a tracking servo and/or tilting servo of the optical pickup 50. Reference numeral 52 indicates a turntable, and reference numeral 53 indicates a clamp for chucking the optical disc D.

The optical pickup 50 includes an optical system having an objective lens 14 that focuses light emitted from a light source onto the optical disc D, and an optical pickup actuator for performing biaxial movement, triaxial movement, or quadriaxial movement of the objective lens 14. The optical pickup actuator uses the optical pickup actuator according to the above-described aspects of the present invention.

Light reflected from the optical disc D is detected by a photodetector provided in the optical pickup 50 and converted into an electric signal. The electric signal is input to the controlling unit 59 via the driving unit 57. The driving unit 57 controls a rotating speed of the spindle motor 55, amplifies the input electric signal, and drives the optical pickup 50. The controlling unit 59 sends focusing servo instructions, tracking servo instructions and/or tilting servo instructions, adjusted based on the electric signal input from the driving unit 57, to the driving unit 57 again, so that a focusing operation, a tracking operation and/or a tilting operation of the optical pickup 50 are performed.

As described above, the aspects of the present invention provide a slimmed optical pickup actuator with a desired tracking efficiency, and an optical recording and/or reproducing apparatus using the same, that utilize a pair of magnetic circuits including a magnet having an improved polarization structure, a single tracking coil per side, and two focusing/tracking coils per side.

A position of a neutral zone along a focusing direction is adjusted using the asymmetry of the magnetic flux intensity distribution, so that tracking sensitivity is improved. Varied ones of the magnetic circuits according to aspects of the present invention are used depending on the requirements of the optical pickup actuator. A driving center of the optical pickup actuator is changed so that rolling can be reduced.

According to aspects of the present invention, biaxial, triaxial, or quadriaxial movements can be performed by controlling a signal input to the magnetic circuits. Linearity of the optical pickup actuators according to aspects of the invention is excellent.

The optical pickup actuator according to an aspect of the present invention may be used in an optical system where height for an optical pickup actuator is restricted. Further since the optical pickup actuator according to an aspect of the present invention can perform tilting without a large sensitivity loss, the optical pickup actuator can be applied to DVD-RAM, DVD±RM, CD-RM, and CD-DVD compatible optical pickups.

Further, the optical pickup actuator according an aspect to the present invention can be applied to CD-RM, DVD-ROM, and CD-DVD compatible optical pickups in which the actuator must be slim and tilting is not required.

Further, an aspect of the present invention can be applied to slim an optical pickup actuator without a having a large tracking efficiency loss.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A magnetic circuit, comprising:
a magnet including first, second, third and fourth magnet parts, the first and second magnet parts disposed adjacent to each other and having opposite polarizations, the third and fourth magnet parts respectively neighboring the first and second magnet parts such that at least two sides thereof are enclosed by the first and second magnet parts, and having opposite polarizations to the first and second magnet parts, respectively;
a tracking coil interacting with the first and second magnet parts generating a driving force in a tracking direction; and
a first focusing/tilting coil interacting with the first and third magnet parts and a second focusing/tilting coil interacting with the second and fourth magnet parts, generating a driving force in at least one of a focusing direction and a tilting direction including the focusing direction.

2. The magnetic circuit according to claim 1, wherein the first and second magnet parts are substantially [symbol] -shaped and symmetric.

3. The magnetic circuit according to claim 2, wherein the first and second magnet parts are substantially [symbol] -shaped and symmetric so that the magnetic circuit is used when a driving center is required to be positioned upward.

4. The magnetic circuit according claim 2, wherein a position of a neutral zone between the first and third magnet parts and a position of a neutral zone between the second and fourth magnet parts along the focusing direction are changeable.

5. The magnetic circuit of claim 4, wherein the position of the neutral zone between the first and third magnet parts and the position of the neutral zone between the second and fourth magnet parts along the focusing direction are changeable in order to optimize a tracking sensitivity.

6. The magnetic circuit according to claim 1, wherein the first and second magnet parts are substantially L-shaped and symmetric.

7. The magnetic circuit according to claim 6, wherein the first and second magnet parts are substantially L-shaped and symmetric so that the magnetic circuit is used when a driving center is required to be positioned downward.

8. The magnetic circuit of claim 6, wherein a position of a neutral zone between the first and third magnet parts and a position of a neutral zone between the second and fourth magnet parts along the focusing direction are changeable.

9. The magnetic circuit of claim 8, wherein the position of the neutral zone between the first and third magnet parts and the position of the neutral zone between the second and fourth magnet parts along the focusing direction are changeable in order to optimize a tracking sensitivity.

10. The magnetic circuit of claim 1, wherein a position of a neutral zone between the first and third magnet parts and a position of a neutral zone between the second and fourth magnet parts along the focusing direction are changeable.

11. The magnetic circuit of claim 1, wherein the position of a neutral zone between the first and third magnet parts and the position of a neutral zone between the second and fourth magnet parts along the focusing direction are changeable in order to optimize a tracking sensitivity.

12. The magnetic circuit of claim 10, wherein the magnet includes a 4-polarization surface-polarized magnet or a pair of 2-polarization surface-polarized magnets.

13. The magnetic circuit according to claim 1, wherein the magnet includes a 4-polarization surface-polarized magnet or a pair of 2-polarization surface-polarized magnets.

14. The magnetic circuit according to claim 1, wherein the magnetic circuit is selectively used for biaxial, triaxial, or quadriaxial movements.

15. The magnetic circuit according to claim 14, wherein the magnetic circuit is selectively used for biaxial, triaxial, or quadriaxial movements by controlling direction of current applied to the first and second focusing/tilting coils.

16. The magnetic circuit according to claim 1, wherein at least one of the first and second focusing/tilting coils and the tracking coil is a fine pattern coil.

17. An optical pickup actuator for an objective lens, comprising:
a base;
a bobbin holding the objective lens;
a support fixed at one end to a holder placed on a side of the base and fixed at the other end to a side surface of the bobbin, and movably supporting the bobbin; and
a pair of magnetic circuits, each of the pair positioned on a different side surface of the bobbin and oppose each other,
wherein the magnetic circuit includes:
a magnet including first, second, third and fourth magnet parts, the first and second magnet parts disposed adjacent to each other and having opposite polarizations, the third and fourth magnet parts respectively neighboring the first and second magnet parts such that at least two sides thereof are enclosed by the first and second magnet parts, and having opposite polarizations to the first and second magnet parts, respectively;
a tracking coil interacting with the first and second magnet parts for generating a driving force in a tracking direction; and
a first focusing/tilting coil interacting with the first and third magnet parts and a second focusing/tilting coil interacting with the second and fourth magnet parts, for driving in at least one of a focusing direction and a tilting direction including the focusing direction.

18. The optical pickup actuator according to claim 17, wherein the first and second magnet parts are substantially [symbol] -shaped and symmetric.

19. The optical pickup actuator according to claim 18, wherein the first and second magnet parts are substantially [symbol] -shaped and symmetric so that the magnetic circuit is used when a driving center is required to be positioned upward.

20. The optical pickup actuator according to claim 18, wherein a position of a neutral zone between the first and third magnet parts and a position of a neutral zone between the second and fourth magnet parts along the focusing direction are changeable.

21. The optical pickup actuator according to claim 20, wherein the position of the neutral zone between the first and third magnet parts and the position of the neutral zone between the second and fourth magnet parts along the focusing direction are changeable in order to optimize a tracking sensitivity.

22. The optical pickup actuator according to claim 17, wherein the first and second magnet parts are substantially L-shaped and symmetric.

23. The optical pickup actuator according to claim 22, wherein the first and second magnet parts are substantially L-shaped and symmetric so that the magnetic circuit is used when a driving center is required to be positioned downward.

24. The optical pickup actuator according to claim 22, wherein a position of a neutral zone between the first and third magnet parts and a position of a neutral zone between the second and fourth magnet parts along the focusing direction are changeable.

25. The optical pickup actuator according to claim 24, wherein a position of a neutral zone between the first and third magnet parts and a position of a neutral zone between the second and fourth magnet parts along the focusing direction are changeable in order to optimize a tracking sensitivity.

26. The optical pickup actuator according to claim 17, wherein a position of a neutral zone between the first and third magnet parts and a position of a neutral zone between the second and fourth magnet parts along the focusing direction are changeable.

27. The optical pickup actuator according to claim 26, wherein the position of the neutral zone between the first and third magnet parts and the position of the neutral zone between the second and fourth magnet parts along the focusing direction are changeable in order to optimize a tracking sensitivity.

28. The optical pickup actuator according to claim 26, wherein the magnet includes a 4-polarization surface-polarized magnet or a pair of 2-polarization surface-polarized magnets.

29. The optical pickup actuator according to claim 17, wherein the magnet includes a 4-polarization surface-polarized magnet or a pair of 2-polarization surface-polarized magnets.

30. The optical pickup actuator according to claim 17, wherein the magnetic circuit can be selectively used for biaxial, triaxial, or quadriaxial movements.

31. The optical pickup actuator according to claim 30, wherein the magnetic circuit is selectively used for biaxial, triaxial, or quadriaxial movements by controlling direction of current applied to the first and second focusing/tilting coils.

32. The optical pickup actuator according to claim 17, wherein at least one of the first and second focusing/tilting coils and the tracking coil is a fine pattern coil.

33. The optical pickup actuator according to claim 17, wherein the end of the support fixed to the side surface that is different from the side surfaces on which the magnetic circuits are positioned.

34. The optical pickup actuator according to claim 17, wherein either one of the first and second focusing/tilting coils and the tracking coil or the magnet is positioned on the side surface of the bobbin, and the other one is installed on the base.

35. An optical recording and/or reproducing apparatus for a disc, comprising:
an optical pickup, comprising:
an optical pickup actuator driving an objective lens movably installed along a radial direction of the disc to record information on the disc and/or reproduce information recorded on the disc,
a focusing servo and a tracking servo; and
a controlling unit controlling the focusing servo and the tracking servo,
wherein the optical pickup actuator includes:
a base,
a bobbin holding the objective lens,
a support fixed at one end to a holder placed on a side of the base and fixed at the other end to a side surface of the bobbin and movably supporting the bobbin, and
a pair of magnetic circuits, each of the pair positioned on a different side surface of the bobbin and oppose each other,
wherein the magnetic circuit includes:
a magnet including first, second, third and fourth magnet parts, the first and second magnet parts disposed adjacent to each other and having opposite polarizations, the third and fourth magnet parts respectively neighboring the first and second magnet parts such that at least two sides thereof are enclosed by the first and second magnet parts, and having opposite polarizations to the first and second magnet parts, respectively;
a tracking coil which interacting with the first and second magnet parts for generating a driving force in a tracking direction; and
a first focusing/tilting coil interacting with the first and third magnet parts and a second focusing/tilting coil which interacts with the second and fourth magnet parts, for generating a driving force in at least one of a focusing direction and a tilting direction including the focusing direction.

36. The optical recording and/or reproducing apparatus according to claim 35, wherein the first and second magnet parts are substantially [symbol] -shaped and symmetric.

37. The optical recording and/or reproducing apparatus according to claim 36, wherein the first and second magnet parts are substantially [symbol] -shaped and symmetric so that the magnetic circuit is used when a driving center is required to be positioned upward.

38. The optical recording and/or reproducing apparatus according to claim 35, wherein the first and second magnet parts are substantially L-shaped and symmetric.

39. The optical recording and/or reproducing apparatus according to claim 38, wherein the first and second magnet parts are substantially L-shaped and symmetric so that the magnetic circuit is used when a driving center is required to be positioned downward.

40. The optical recording and/or reproducing apparatus according to claim 35, wherein a position of a neutral zone between the first and third magnet parts and a position of a neutral zone between the second and fourth magnet parts along the focusing direction are changeable.

41. The optical recording and/or reproducing apparatus according to claim 40, wherein the position of the neutral zone between the first and third magnet parts and the position of the neutral zone between the second and fourth magnet parts along the focusing direction are changeable in order to optimize a tracking sensitivity.

42. The optical recording and/or reproducing apparatus according to claim 35, wherein the magnet includes a 4-polarization surface-polarized magnet or a pair of 2-polarization surface-polarized magnets.

43. The optical recording and/or reproducing apparatus according to claim 35, wherein the magnetic circuit can be selectively used for biaxial, triaxial, or quadriaxial movements.

44. The optical recording and/or reproducing apparatus according to claim 43, wherein the magnetic circuit can be selectively used for biaxial, triaxial, or quadriaxial movements by controlling direction of current applied to the first and second focusing/tilting coils of the pair of magnetic circuits.

45. The optical recording and/or reproducing apparatus of claim 35, wherein at least one of the first and second focusing/tilting coils and the tracking coil is a fine pattern coil.

46. A magnetic circuit on a base, comprising:
a first magnet and a second magnet having opposite polarizations and adjacent to each other on the base;
a third magnet partially enclosed by the first magnet and having an opposite polarization to the first magnet;
a fourth magnet partially enclosed by the second magnet and having an opposite polarization to the second magnet;
a tracking coil interacting with the first and second magnets;
a first focusing/tilting coil interacting with the first and third magnets; and
a second focusing/tilting coil interacting with the second and fourth magnets.

47. The magnetic circuit according to claim 46, wherein the tracking coil generates a driving force in a tracking direction, the first and second focusing/tilting coils generate a driving force in at least one of a focusing direction and a tilting direction including the focusing direction.

48. The magnetic circuit according to claim 47, wherein the first and second magnets are substantially L-shaped and symmetric.

49. The magnetic circuit according claim 47, wherein a position of a neutral zone between the first and third magnets and a position of a neutral zone between the second and fourth magnets along a focusing direction are changeable.

50. The magnetic circuit according to claim 49, wherein a position of the neutral zone between the first and third magnets and the position of the neutral zone between the second and fourth magnets along the focusing direction are changed to optimize a tracking sensitivity.

51. The magnetic circuit according to claim 47, wherein the first, second, third, and fourth magnets are parts of either one of a 4-polarization surface-polarized magnet or a pair of 2-polarization surface-polarized magnets.

52. The magnetic circuit according to claim 47, wherein the magnetic circuit is selectively used for biaxial, triaxial, or quadriaxial movements by controlling the direction of current applied to the first and second focusing/tilting coils.

53. The magnetic circuit according to claim 47, wherein at least one of the first and second focusing/tilting coils and the tracking coil is a fine pattern coil.

54. An optical pickup actuator for an objective lens, comprising:
a base;
a bobbin holding the objective lens;
supports each having one end fixed to a holder placed on a side of the base and each having the other end fixed a side surface of the bobbin, and movably supporting the bobbin; and
a pair of magnetic circuits, each of the pair positioned on a different side surface of the bobbin and oppose each other,
wherein the magnetic circuit includes:
a first magnet and a second magnet having opposite polarizations and adjacent to each other on the base,
a third magnet partially enclosed by the first magnet and having an opposite polarization to the first magnet,
a fourth magnet partially enclosed by the second magnet and having an opposite polarization to the second magnet,
a tracking coil interacting with the first and second magnets,
a first focusing/tilting coil interacting with the first and third magnets, and
a second focusing/tilting coil interacting with the second and fourth magnets.

55. The optical pickup actuator according to claim 54, wherein the tracking coil generates a driving force in a tracking direction, and the first and second focusing/tilting coils generate a driving force in at least one of a focusing direction and a tilting direction including the focusing direction.

56. The optical pickup actuator according to claim 54, wherein the first and second magnets are substantially L-shaped and symmetric.

57. The optical pickup actuator according claim 54, wherein a position of a neutral zone between the first and third magnets and a position of a neutral zone between the second and fourth magnets along a focusing direction are changeable.

58. The optical pickup actuator according to claim 57, wherein a position of the neutral zone between the first and third magnets and the position of the neutral zone between the second and fourth magnets along the focusing direction are changed to optimize a tracking sensitivity.

59. The optical pickup actuator according to claim 54, wherein the first, second, third, and fourth magnets are parts of either one of a 4-polarization surface-polarized magnet or a pair of 2-polarization surface-polarized magnets.

60. The optical pickup actuator according to claim 54, wherein the magnetic circuit is selectively used for biaxial, triaxial, or quadriaxial movements by controlling the direction of current applied to the first and second focusing/tilting coils.

61. The optical pickup actuator according to claim 54, wherein at least one of the first and second focusing/tilting coils and the tracking coil is a fine pattern coil.

62. The optical pickup actuator according to claim 54, wherein the actuator is applied to CD-RM, DVD-ROM, and CD-DVD compatible optical pickups.

63. The optical pickup actuator according to claim 54, wherein the supports are wires or plate springs.

64. The optical pickup actuator according to claim 54, wherein the number of supports is four or six.

65. The optical pickup actuator according to claim 54, wherein the tracking coils and the first and second focusing/tilting coils are substantially rectangular in shape.

66. An optical pickup for an optical disc, comprising:
an objective lens focusing light emitted from a light source; and
an optical pickup actuator performing biaxial, triaxial, or quadriaxial movements by controlling the direction of current applied to the first and second focusing/tilting coils.

67. The optical pickup according to claim 66, wherein the optical pickup actuator comprises:
a base,
a bobbin holding the objective lens,
supports each having one end fixed to a holder placed on a side of the base and each having the other end fixed a side surface of the bobbin, and movably supporting the bobbin, and
a pair of magnetic circuits, each of the pair positioned on a different side surface of the bobbin and oppose each other,
wherein the magnetic circuit includes:
a first magnet and a second magnet having opposite polarizations and adjacent to each other on the base,
a third magnet partially enclosed by the first magnet and having an opposite polarization to the first magnet,
a fourth magnet partially enclosed by the second magnet and having an opposite polarization to the second magnet,
a tracking coil interacting with the first and second magnets,
a first focusing/tilting coil interacting with the first and third magnets, and
a second focusing/tilting coil interacting with the second and fourth magnets.

68. The optical pickup according to claim 67, wherein the tracking coil generates a driving force in a tracking direction, and the first and second focusing/tilting coils generate a driving force in at least one of a focusing direction and a tilting direction including the focusing direction.

69. The optical pickup according to claim 67, wherein the first and second magnets are substantially L-shaped and symmetric.

70. The optical pickup according claim 67, wherein a position of a neutral zone between the first and third magnets and a position of a neutral zone between the second and fourth magnets along a focusing direction are changeable.

71. The optical pickup according to claim 70, wherein a position of the neutral zone between the first and third magnets and the position of the neutral zone between the second and fourth magnets along the focusing direction are changed to optimize a tracking sensitivity.

72. The optical pickup according to claim 67, wherein the first, second, third, and fourth magnets are parts of either one of a 4-polarization surface-polarized magnet or a pair of 2-polarization surface-polarized magnets.
